(19) United States
(12) Patent Application Publication
(10) Pub. No.: US 2008/0147710 A1
(43) Pub. Date: Jun. 19, 2008

(54) GENERATING WEB PAGES UTILIZING USER-DEFINED SEARCH PARAMETERS

(75) Inventors: Ramez Naam, Seattle, WA (US); Zachary M. Gutt, Seattle, WA (US); Eric M. Schurman, Seattle, WA (US); Gary William Flake, Bellevue, WA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: MICROSOFT CORPORATION, Redmond, WA (US)

(21) Appl. No.: 11/612,836

(22) Filed: Dec. 19, 2006

(51) Int. Cl. G06F 17/30; G06F 7/00

(52) U.S. Cl. 707/102; 707/3; 707/E17.005; 707/E17.014

(57) ABSTRACT

Computerized methods and systems for generating a URL-addressable Web page utilizing user-defined search parameters are provided. User-defined search parameters are packaged together as a search macro and assigned a URL. When a user accesses the Web page associated with the assigned URL, s/he is permitted to specify a search query and any search results returned in response thereto will be tailored in accordance with the user-defined search parameters, even though such search parameters are not input as part of the search query. The present invention further provides users with the opportunity to readily share packaged search parameters with other users by simply communicating the URL assigned to a particular search macro.

### BACKGROUND

In hypermedia systems preceding the Web, and on the Web since its inception, users have employed a variety of tools to aid in navigating available information. For example, users often utilize search engines specifically designed for information retrieval. Additionally, more savvy users may create search macros that package user-defined search parameters into a single identifiable unit. This is particularly useful for users that desire to utilize advanced search engine syntax, such as Boolean operators, and for users that wish to perform multiple queries utilizing the same user-defined parameters. Search macros alter the scope of search results that will be returned in response to a search query according to the user-defined search parameters. Thus, fewer search results that are irrelevant to the user will be returned compared to the same search query being conducted by standard Web search engines without the syntax packaged as the search macro.

Search macros permit users to execute searches using advanced search engine syntax by referencing a specific search macro name and entering a search query. When using search macros, a user must input the exact search macro name each and every time the macro is to be utilized. Not only is this a rather cumbersome task, it is also too sophisticated for some Internet users. In addition, the need to enter macro-specific syntax with every search query restricts the ability to easily share these user-defined search parameters with other Internet users. Accordingly, search macro utility is typically limited to only a fraction of Internet users.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Embodiments of the present invention relate to generating a uniform resource locator (URL)-addressable Web page utilizing user-defined search parameters. User-defined search parameters are packaged together and assigned a URL. When a user accesses the Web page associated with the assigned URL, s/he will be permitted to specify a simple search query and any search results returned in response thereto will be tailored in accordance with the user-defined search parameters. Additionally, users may share packaged search parameters with other users by simply communicating the URL assigned thereto.

### BRIEF DESCRIPTION OF THE DRAWINGS

The present invention is described in detail below with reference to the attached drawing figures, wherein:

FIG. 1 is a block diagram of an exemplary computing environment suitable for use in implementing the present invention;

FIG. 2 is a block diagram of an exemplary computing system for generating a URL-addressable Web page associated with user-defined search parameters, for communicating the URL-addressable Web page, and for conducting searches utilizing the user-defined search parameters, in accordance with an embodiment of the present invention;

FIG. 3 is a flow diagram showing a method for generating a Web page associated with user-defined search parameters, in accordance with an embodiment of the present invention;

FIG. 4 is a flow diagram showing a method for generating a Web page associated with user-defined search parameters, in accordance with an embodiment of the present invention, the method having more detail than the method of FIG. 3;

FIG. 5 is a flow diagram showing a method for determining search results utilizing user-defined search parameters associated with a Web page, in accordance with an embodiment of the present invention;

FIG. 6 is a flow diagram showing a method for determining search results utilizing user-defined search parameters associated with a Web page, in accordance with an embodiment of the present invention, the method having more detail than the method of FIG. 5;

FIG. 7 is an illustrative screen display of an exemplary user interface for receiving user-defined search parameters, in accordance with an embodiment of the present invention;

FIG. 8 is an illustrative screen display of an exemplary user interface for receiving user-defined search parameters, in accordance with an embodiment of the present invention;

FIG. 9 is an illustrative screen display of an exemplary user interface for receiving user-defined customization values, in accordance with an embodiment of the present invention;

FIG. 10 is an illustrative screen display of an exemplary user interface for receiving a search query from a Web page associated with user-defined search parameters, in accordance with an embodiment of the present invention; and

FIG. 11 is an illustrative screen display of an exemplary user interface for displaying results of a search query utilizing an expanded search query, in accordance with an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present invention provide computerized methods and systems, for generating a uniform resource locator (URL)-addressable Web page utilizing user-defined search parameters. User-defined search parameters are packaged together and assigned a URL. When a user accesses the Web page associated with the assigned URL, s/he will be permitted to specify a simple search query and any search results returned in response thereto will be tailored in accordance with the user-defined search parameters. Additionally, users may share packaged search parameters with other users by simply communicating the URL assigned thereto. Embodiments of the present invention further provide computer-readable media having computer-executable instructions thereon for performing the methods described herein.

Accordingly, embodiments of the present invention provide computer-readable media having computer-executable instructions embodied thereon for performing a method for generating a URL-addressable Web page utilizing at least one user-defined search parameter. In one embodiment, the method includes receiving the at least one user-defined search parameter and automatically generating the URL-addressable Web page, the URL-addressable Web page being associated with the at least one user-defined search parameter. If desired, the method may further include assigning a URL to the URL-addressable Web page, receiving a request to communicate the at least one user-defined search parameter and, in response to the received request, communicating the assigned URL.

Embodiments of the present invention further provide computer systems for generating a URL-addressable Web page utilizing at least one user-defined search parameter. In one embodiment, the system includes a search parameter receiving module, a Web page generating module and a URL assigning module. The search parameter receiving module is configured to receive the at least one user-defined search parameter. The Web page generating module is configured to generate the URL-addressable Web page upon receipt of the at least one user-defined search parameter. The URL assigning module is configured to assign a URL to the generated URL-addressable Web page. If desired, the computer system may further include one or more of a user-defined customization value receiving module configured to receive at least one user-defined customization value associated with the URL-addressable Web page; a communication module configured to receive a request to communicate the at least one user-defined search parameter and, in response to the received request, communicate the assigned URL; a search query receiving module configured to receive a search query; and a determining module configured to determine one or more search results utilizing the search query and the at least one user-defined search parameter.

Additional embodiments of the present invention provide computerized methods for determining at least one search result associated with a search query. In one embodiment, the method includes receiving a request to display a URL-addressable Web page associated with at least one user-defined search parameter, receiving a search query, and determining the at least one search result associated with the search query utilizing the received search query and the at least one user-defined search parameter.

Having briefly described an overview of embodiments of the present invention, an exemplary operating environment suitable for implementing the present invention is described below.

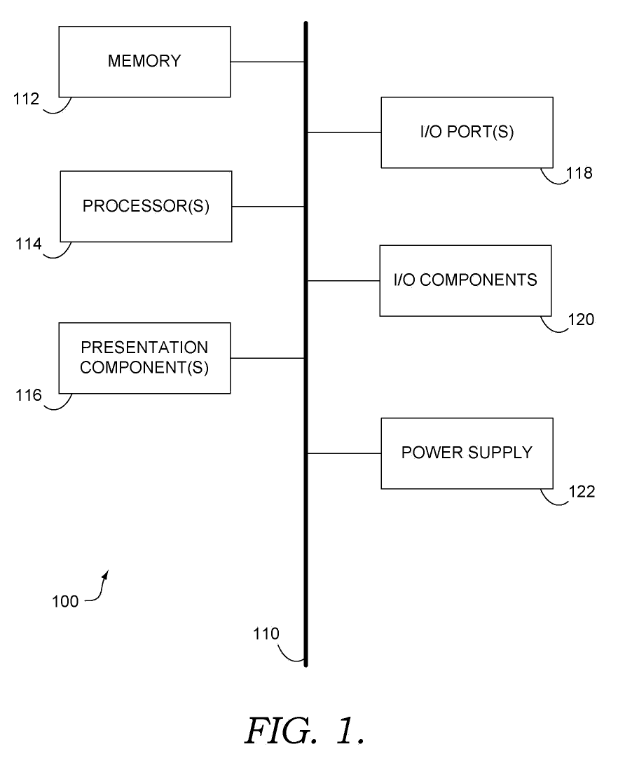

Referring to the drawings in general, and initially to FIG. 1 in particular, an exemplary operating environment for implementing the present invention is shown and designated generally as computing device 100. Computing device 100 is but one example of a suitable computing environment and is not intended to suggest any limitation as to the scope of use or functionality of the invention. Neither should the computing environment 100 be interpreted as having any dependency or requirement relating to any one or combination of components/modules illustrated.

The invention may be described in the general context of computer code or machine-useable instructions, including computer-executable instructions such as program components, being executed by a computer or other machine, such as a personal data assistant or other handheld device. Generally, program components including routines, programs, objects, components, data structures, and the like, refer to code that performs particular tasks, or implement particular abstract data types. The invention may be practiced in a variety of system configurations, including hand-held devices, consumer electronics, general-purpose computers, specialty computing devices, etc. The invention may also be practiced in distributed computing environments where tasks are performed by remote-processing devices that are linked through a communications network.

With continued reference to FIG. 1, computing device 100 includes a bus 110 that directly or indirectly couples the following devices: memory 112, one or more processors 114, one or more presentation components 116, input/output (I/O) ports 118, I/O components 120, and an illustrative power supply 122. Bus 10 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. We recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

Computing device 100 typically includes a variety of computer-readable media. By way of example, and not limitation, computer-readable media may comprise Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices, carrier wave or any other medium that can be used to encode desired information and be accessed by computing device 100.

Memory 112 includes computer-storage media in the form of volatile and/or nonvolatile memory. The memory may be removable, non-removable, or a combination thereof. Exemplary hardware devices include solid-state memory, hard drives, optical-disc drives, etc. Computing device 100 includes one or more processors that read data from various entities such as memory 112 or I/O components 120. Presentation component(s) 116 present data indications to a user or other device. Exemplary presentation components include a display device, speaker, printing component, vibrating component, etc.

I/O ports 118 allow computing device 100 to be logically coupled to other devices including I/O components 120, some of which may be built in. Illustrative components include a microphone, joystick, game pad, satellite dish, scanner, printer, wireless device, etc.

As previously mentioned embodiments of the present invention relate to generating a URL-addressable Web page associated with user-defined search parameters. Utilizing embodiments of the present invention, users may specify search parameters that are packaged together as a single unit and assigned a URL address. Upon accessing the Web page (e.g., by inputting the URL address), the user is presented with an option for inputting a search query. Upon receipt of the search query, the packaged search parameters are appended thereto to create an expanded search query and a search is conducted utilizing the expanded search query. As such, the results returned in response to the search query are more targeted to the user's interests than the results of the same search being conducted utilizing a standard search engine, e.g., a Web search engine, a video search engine, an image search engine, a book search engine, and the like. Embodiments of the present invention further relate to sharing packaged search parameters by communicating the URL address assigned thereto.

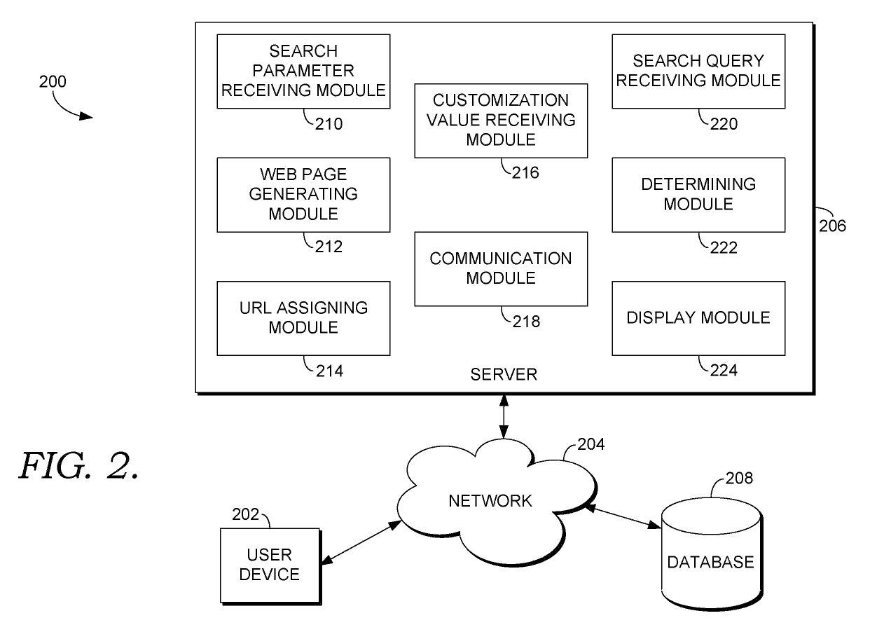

Turning now to FIG. 2, a block diagram is illustrated that shows an overall system architecture 200 for generating a URL-addressable Web page utilizing at least one user-defined search parameter in accordance with embodiments of the present invention. It will be understood and appreciated by those of ordinary skill in the art that the overall system architecture 200 shown in FIG. 2 is merely an example of one suitable computing environment and is not intended to suggest any limitation as to the scope of use or functionality of the present invention. Neither should the overall system architecture 200 be interpreted as having any dependency or requirement related to any single component/module or combination of components/modules illustrated therein.

System 200 includes a user device 202 connected to a server 206 and a database 208 via a network 204. Each of the user device 202 and the server 206 shown in FIG. 2 may be any type of computing device, such as, for example, computing device 100 described above with reference to FIG. 1. By way of example only and not limitation, the user device 202 and/or the server 206 may be a personal computer, desktop computer, laptop computer, handheld device, consumer electronic device, and the like. It should be noted, however, that the invention is not limited to implementation on such computing devices, but may be implemented on any of a variety of different types of computing devices within the scope of embodiments of the present invention.

As shown in FIG. 2, the server 206 includes a search parameter receiving module 210, a Web page generating module 212, a URL assigning module 214, a customization value receiving module 216, a communication module 218, a search query receiving module 220, a determining module 222, and a display module 224 for implementing embodiments of the present invention. In some embodiments, the modules 210, 212, 214, 216, 218, 220, 222, and 224 may be implemented as stand-alone applications. In other embodiments, the modules 210, 212, 214, 216, 218, 220, 222, and 224 may be integrated directly into the operating system for the server 206. It will be understood by those skilled in the art that the modules 210, 212, 214, 216, 218, 220, 222, and 224 illustrated in FIG. 2 are exemplary in nature and in number and should not be construed as limiting. Any number of modules may be employed to achieve the desired functionality within the scope of embodiments of the present invention.

The search parameter receiving module 210 is configured to receive at least one user-defined search parameter, each user-defined search parameter being associated with an attribute of a desirable search result. By way of example only, suppose a user desires search results returned in response to a search query to include recipes and to exclude information unrelated to cooking. In this instance, the user may define a search parameter that restricts returned results to information obtained from Web pages that relate to cooking. A search on a search query containing the word “liver” that is conducted utilizing the exemplary user-defined search parameter may return a list of liver recipes while restricting information from medical and liver health Web pages from being returned. As more fully described below, a subsequent search query containing the word “oregano”, and including no further limitations in the query, if conducted in accordance with the user-defined search parameter, will likely return a list of recipes including oregano rather than information from gardening web sites regarding how to properly cultivate oregano.

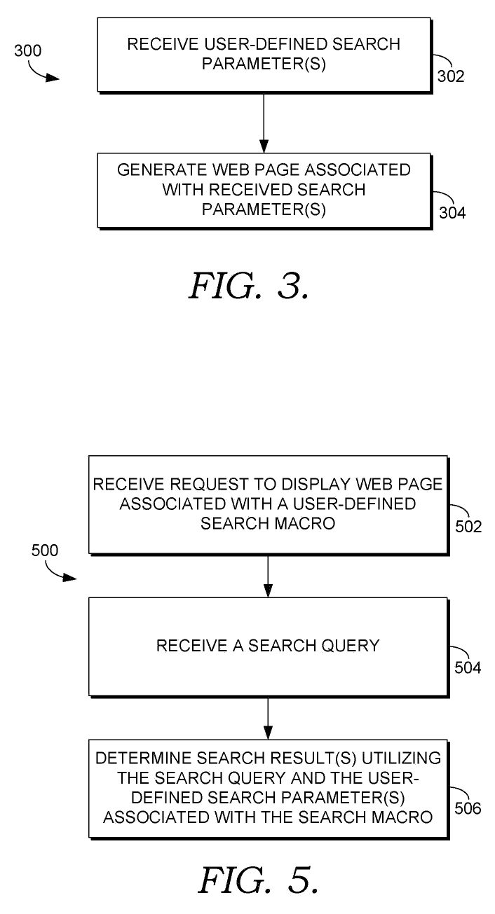

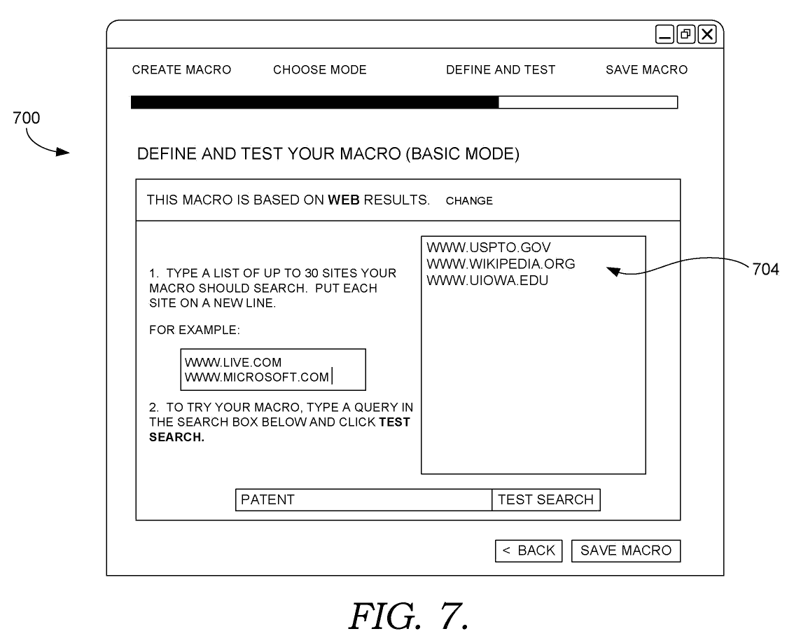

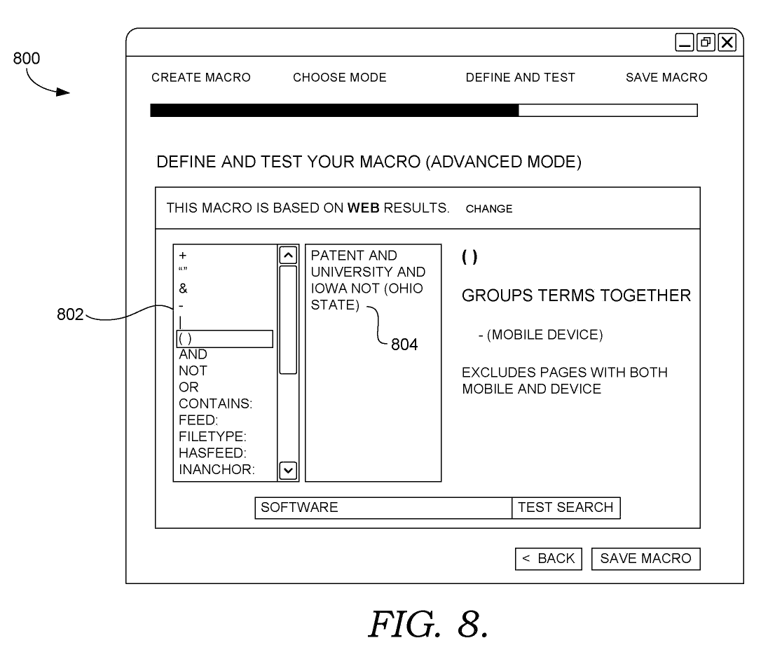

It will be understood and appreciated by those of ordinary skill in the art that multiple methods exist by which a user may input a user-defined search parameter into the search parameter receiving module 210. For instance, search parameters may be input, by way of example only, utilizing a keyboard, joystick, trackball, or the like. Exemplary user interfaces 700 and 800 for defining search parameters illustrated in FIGS. 7 and 8, respectively. In one embodiment, e.g., the embodiment illustrated in the user interface 700 of FIG. 7, at least one user-defined search parameter may be input by the user by specifying a URL assigned to a particular Web site. Upon entry of at least one URL, a URL search list is created and indicates that a search will be restricted to the Web pages associated with the listed URLs. As such, the search restriction to the URL search list comprises a user-defined search parameter that may be stored, e.g., in association with database 208. The user-defined search parameter may subsequently be utilized to conduct restricted searches, as more fully described below with reference to FIGS. 3-6.

In another embodiment, e.g., the embodiment illustrated in the user interface 800 of FIG. 8, at least one user-defined search parameter may be input by the user specifying desired search engine syntax. In accordance with this embodiment, a user will typically input search engine syntax in the form of a plurality of keywords related to one another by way of one or more Boolean commands, e.g., selected from a Boolean command list 802. As such, the specified search engine syntax comprises a user-defined search parameter that may be stored, e.g., in association with database 208 of FIG. 2. The user-defined search parameter may subsequently be utilized to conduct restricted searches, as more fully described below with reference to FIGS. 3-6.

It will be understood and appreciated by those of ordinary skill in the art that methods for inputting user-defined search parameters are not limited to the embodiments described herein and that user interfaces providing for input of such user-defined search parameters may vary accordingly.

The Web page generating module 212 is configured to generate a URL-addressable Web page upon receipt of at least one user-defined search parameter. As discussed above, user-defined search parameters may be input in a variety of ways and may be stored in association with database 208, server 206, in other locations in the system 200, or any combination thereof. In one embodiment the Web page generating module 212 utilizes user-defined search macros to generate a URL-addressable Web-page associated therewith.

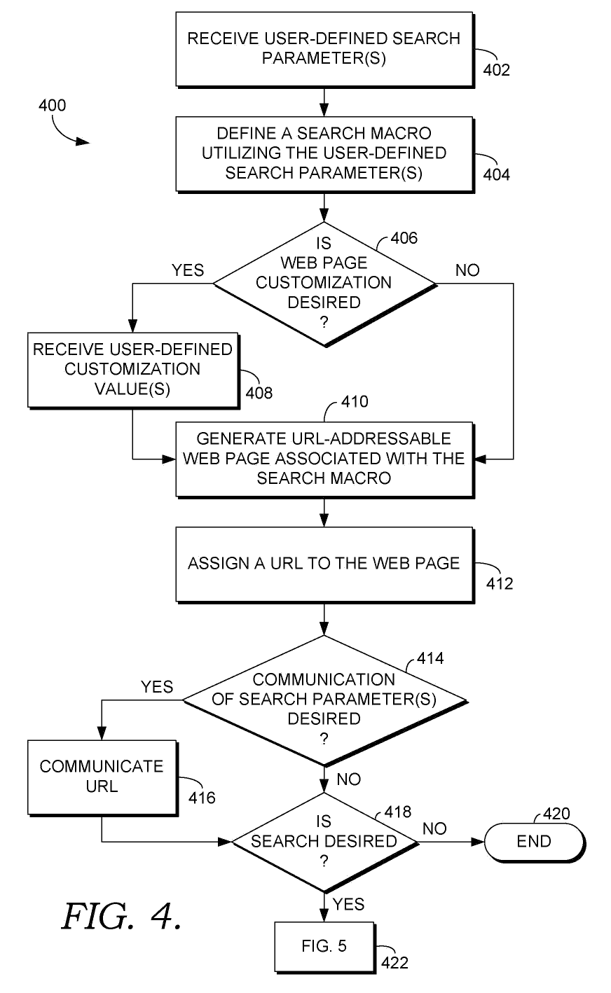

More particularly, the Web page generating module 212 is in communication with the search parameter receiving module 210. As such, the Web page generating module 212 receives one or more user-defined search parameter(s) from the search parameter receiving module 210 in the form of search engine syntax. The search engine syntax is then packaged into a search macro (as more fully described below with reference to FIG. 4). If desired, the user interface may prompt the user to elect to customize the Web page. If the user desires to customize the Web page, a variety of user-defined customization values may be entered into a customization value receiving module 216, as more fully described below with reference to FIG. 4. The search macro may then be stored, e.g., in association with database 208. Upon storing the search macro, the Web page generating module 212 will automatically generate a web page associated with the search that will exemplify the user-defined search parameters upon executing a search, as more fully described below.

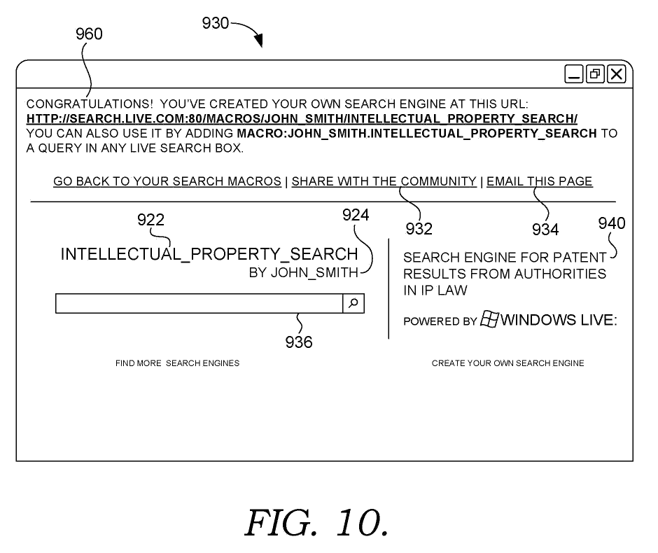

The URL assigning module 214 is in communication with the Web page generating module 212 and is configured to assign a URL to a URL-addressable Web page generated there from. Typically, the URL assigning module 214 will automatically assign the URL to the URL-addressable Web page upon election by the user to store the user-defined search parameters (see FIG. 4). In one embodiment, the URL that is assigned to the Web page is comprised of user-defined customization values that are entered into the customization value receiving module 216, as more fully described below. In particular, the customization values of a page title and author name may be combined to form part of the URL, e.g., as shown in user interface 930 of FIG. 10. Utilizing the page title and author name in the URL that is assigned to the URL-addressable Web page facilitates identification of the search parameters incorporated in the Web page and assists users in recalling the URL when communicating it with another user.

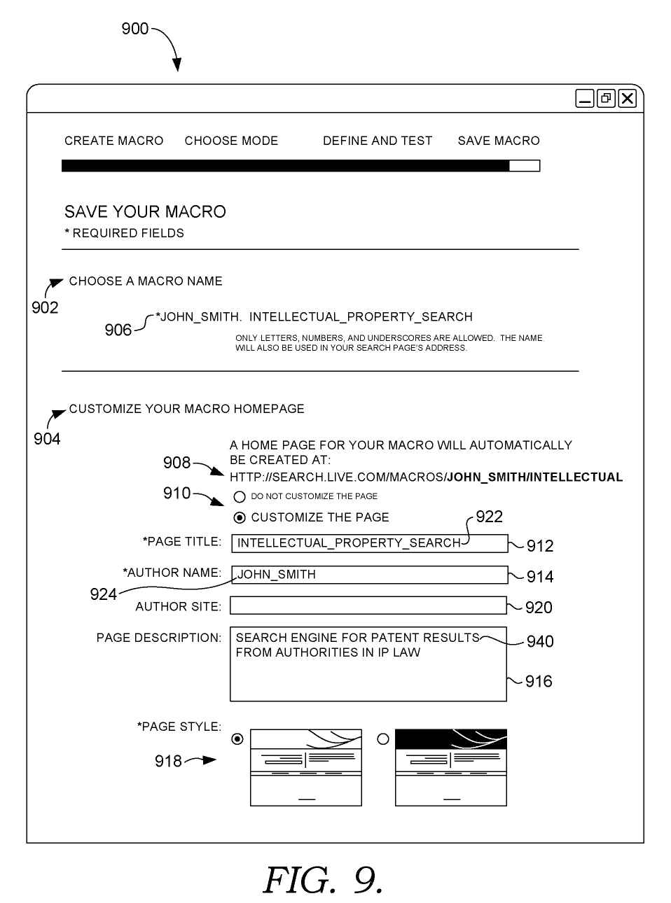

The customization value receiving module 216 is configured to receive at least one user-defined customization value associated with the URL-addressable Web page. User-defined customization values may include, by way of example only, a Web page title, a Web page author identification, a Web page description, a Web page graphical appearance indicator, and a security level. The customization value receiving module 216 will typically accept customization values input by a user in response to prompts displayed in association with a user interface. An exemplary user interface, which may be utilized in association with the customization value receiving module 216, is more fully described below with reference to FIG. 9.

The communication module 218 is configured to receive a request to communicate at least one user-defined search parameter to one or more users. In one embodiment, the communication module 218 shares the URL address of the Web page upon user actuation of an email link displayed on the user interface such that an email with the URL address attached (or referenced therein) is automatically generated. This and alternate exemplary communication methods, which assist in sharing the URL address with other users via the communication module 218, are more fully described below with reference to FIG. 10.

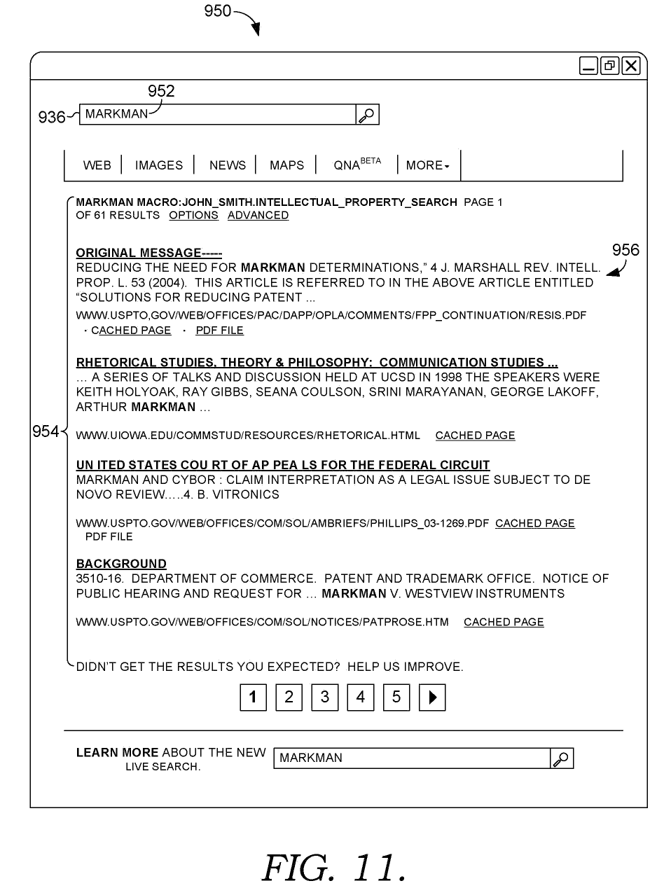

The search query receiving module 220 is configured to receive a search query input by a user. The user is typically permitted to input a simple search query into a query-receiving area, e.g., query-receiving area 936 illustrated in FIGS. 10 and 11. If desired, the query receiving-area may display the search query such that it can be viewed and modified by the user. When satisfied with the displayed search query, the search query may be stored, e.g., to database 208, and/or a search may be executed. Note that utilizing the systems and methods described herein, the user need only enter a simple search query (e.g., “liver”) and not the search engine syntax associated with the user-defined search parameters. In this way, the user is able to get targeted and desired search results with minimal input into the search query. This functionality of embodiments of the present invention is more fully described below.

The determining module 222 is configured to determine one or more search results utilizing a search query, e.g., a search query input into search query receiving module 220, and at least one user-defined search parameter, e.g., input utilizing search parameter receiving module 210. Upon execution, the determining module 222 will typically retrieve a stored search query and at least one user-defined search parameter associated with the Web page from which the search is initiated. The determining module 222 appends the retrieved user-defined search parameter(s) to the search query to create an expanded search query. Subsequently, the expanded search query is utilized to determine search results of the search query. All determined search results will be tailored in accordance with the user-defined search parameters, even though such user-defined search parameters are not input with the search query.

The display module 224 is configured to display the URL-addressable Web page associated with user-defined search parameter(s) and/or any search results determined in response to an initiated search. Such Web page and results may be displayed, e.g., on a user interface display. In one embodiment, the display module 224 displays determined search results as a list of at least one reference, for instance, a Web page reference (see user interface 950 of FIG. 11).

Turning now to FIG. 3, a flow diagram is illustrated that shows a method 300 for generating a Web page associated with at least one user-defined search parameter, in accordance with an embodiment of the present invention. Initially, as indicated at block 302, at least one user-defined search parameter is received, e.g., utilizing search parameter receiving module 210 of FIG. 2. As previously described, such user-defined search parameters may include, by way of example only, one or more Web sites the user desires to have searched, or one or more keywords the user desires all results to contain, such keywords being connected utilizing at least one Boolean operator, if desired. Exemplary user interfaces 700 and 800 for inputting user-defined search parameters are illustrated and more fully described below with reference to FIGS. 7 and 8. Subsequently, as indicated at block 304, a Web page associated with the received search parameter(s) is generated, e.g., utilizing Web page generating module 212 of FIG. 2. A search subsequently initiated from the generated Web page will return results in accordance with the user-defined search parameter(s), as more fully described below.

With reference to FIG. 4, a flow diagram is illustrated that shows a method 400 for generating a Web page associated with user-defined search parameters, in accordance with an embodiment of the present invention, the method having more detail than the method of FIG. 3. Initially, as indicated at block 402, at least one user-defined search parameter is received, e.g., utilizing search parameter receiving module 210 of FIG. 2. Exemplary user interfaces 700 and 800 for inputting user-defined search parameters are illustrated and more fully described below with reference to FIGS. 7 and 8. Subsequently, as indicated at block 404, all input user-defined search parameters are packaged together to define a search macro. Methods for packaging user-defined search parameters into search macros are known to those of ordinary skill in the art and, accordingly, are not further described herein.

Next, as indicated at block 406, it is determined whether customization of the Web page that will be associated with the search macro, that is, associated with the user-defined search parameters, is desired. If customization is desired, one or more user-defined customization values are subsequently received, e.g., utilizing customization value receiving module 216 of FIG. 2, as indicated at block 408. User-defined customization values may include, by way of example only and not limitation, a Web page title, a Web page author identification, the URL of a Web page associated with the Web page author and/or Web page title, a Web page description, a Web page graphical appearance indicator (e.g., a page style indicator such as selectable indicator 918), and a security level (i.e., an indication whether the user desires the Web page to be publicly accessible or have access restricted to a delineated list of users). An exemplary user interface 900 for permitting customization of the Web page associated with a search macro is illustrated and more fully described below with reference to FIG. 9.

Once all user-defined customization values have been received, or if it is determined at block 406 that customization of the associated Web page is not desired, a URL-addressable Web page is generated, e.g., utilizing web page generating module 212 of FIG. 2, and associated with the search macro. This is indicated at block 410. Subsequently, a URL is assigned to the Web page, e.g., utilizing URL assigning module 214 of FIG. 2, as indicated at block 412.

In one embodiment, a user may subsequently be provided with the option to share the user-defined search parameter(s) with other users, for instance, by automatically-generated email message, or the like. Accordingly, as indicated at block 414, it is next determined whether communication of the search parameter(s) associated with the search macro to one or more additional users is desired. If communication/sharing is desired, the assigned URL is subsequently communicated (e.g., utilizing communication module 218 of FIG. 2) to a delineated list of users or, if desired, published on a search macro gallery maintained, for instance, by server 206 of FIG. 2. This is indicated at block 416. It will be understood by those of ordinary skill in the art that a variety of methods for communicating the assigned URL may be utilized. Any and all such methods are intended to be within the scope of embodiments hereof.

It is subsequently determined, as indicated at block 418, if a search utilizing the user-defined search parameters (i.e., the search macro) is desired. If a search is not desired, the method ends, as indicated at block 420, and the search parameters and corresponding URL are stored for future use, for instance, in association with database 208. If, however, it is determined that a search is desired utilizing the user-defined search parameters, the method proceeds to FIG. 5, as indicated at block 422.

Turning now to FIG. 5, a flow diagram is illustrated that shows a method 500 for determining search results utilizing user-defined search parameters associated with a Web page, in accordance with an embodiment of the present invention. Initially, as indicated at block 502, a request to display a Web page associated with a user-defined search macro is received. Such request may be received in a variety of ways including, but not limited to, selection of a link in an automatically generated email message communicating the associated URL, selection of the associated URL from a search macro gallery maintained, for instance, by server 206 of FIG. 2, or input of the associated URL into a Web browser. It will be understood by those of ordinary skill in the art that the present invention is not intended to be limited to any particular mode of receipt.

Next, a search query is received, e.g., utilizing search query receiving module 220 of FIG. 2, as indicated at block 504. A user interface 930 having a query-receiving area associated therewith configured to receive a search query is illustrated and more fully described below with reference to FIG. 10. Subsequently, one or more search results are determined, e.g., utilizing determining module 222 of FIG. 2, in accordance with both the search query and the user-defined search parameter(s) associated with the search macro. This is indicated at block 506.

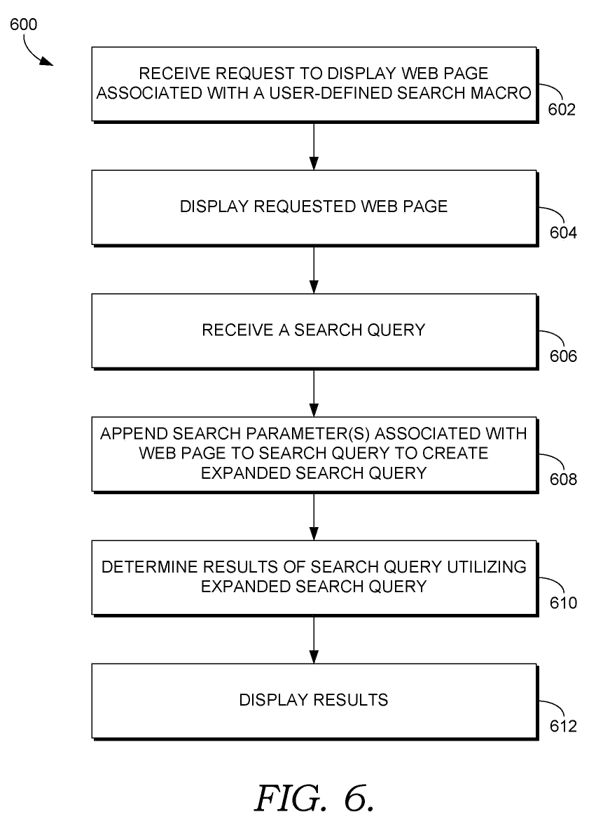

Turning now to FIG. 6, a flow diagram is illustrated that shows a method 600 for determining search results utilizing user-defined search parameters associated with a Web page, in accordance with an embodiment of the present invention, the method having more detail than the method of FIG. 5. Initially, as indicated at block 602, a request to display a Web page associated with a user-defined search macro is received. As previously described, such request may be received in a variety of ways including, but not limited to, selection of a link in an automatically generated email message communicating the associated URL, selection of the associated URI from a search macro gallery maintained, for instance, by server 206 of FIG. 2, or input of the associated URL into a Web browser. Subsequently, as indicated at block 604, the requested Web page, that is, the Web page associated with the URL and the user-defined search parameters is displayed, e.g., utilizing display module 224 of FIG. 2. Included in association with the displayed Web page is at least one query-receiving area, e.g., query-receiving area 936 shown in FIGS. 9 and 10, configured to receive a search query. Next, as indicated at block 606, a search query is received, e.g., utilizing search query receiving module 220 of FIG. 2.

As the search query is input into a query-receiving area associated with a Web page having user-defined search parameters associated therewith, results satisfying the search query will also satisfy the user-defined search parameters, even though such search parameters are not separately input into the query-receiving area. Accordingly, as indicated at block 608, the user-defined search parameter(s) associated with the Web page are appended to the search query to create an expanded search query. The results of the search are subsequently determined (e.g., utilizing determining module 222 of FIG. 2) using the expanded search query, as indicated at block 610, and displayed (e.g., utilizing display module 224 of FIG. 2), as indicated at block 612.

Turning now to FIGS. 7 and 8, illustrative screen displays 700 and 800, respectively, illustrating exemplary user interfaces for accepting one or more user-defined search parameters, based upon desired search result attributes, are shown in accordance with embodiments of the present invention. In FIG. 7 a list of Web sites has been input as a user-defined search parameter and in FIG. 8, a plurality of keywords associated with one another via Boolean commands has been input as a user-defined search parameter. Each of screen displays 700 and 800 is more fully described below.

With initial reference to FIG. 7, a user interface 700 is shown having a URL search list display area 704. Upon entry of at least one URL address into a URL-receiving area, a URL search list is created and displayed in association with the URL search list display area 704. The URL search list restricts any search conducted in accordance with the search macro to the listed Web pages. As such, search restriction to a URL search list comprises at least one user-defined search parameter.

Turning now to FIG. 8, a user interface 800 is shown from which a user may input at least one user-defined search parameter in the form of a desired search engine syntax 804. In accordance with this embodiment, a user will typically input the search engine syntax 804 in the form of a plurality of keywords related to one another by way of one or more Boolean commands, e.g., selected from a Boolean command list 802. As such, the specified search engine syntax 804 comprises a user-defined search parameter that may be stored, e.g., in association with database 208 of FIG. 2, and/or packaged with other user-defined search parameters in the form of a search macro.

With reference to FIG. 9, an illustrative screen display of an exemplary user interface for accepting customization values, e.g., utilizing customization value receiving module 216 of FIG. 2, is shown and designated generally as reference numeral 900. In FIG. 9, a page title, author name, and page description are shown for exemplary purposes. The user interface 900 includes a macro name display area 902, a customization option display area 904, a URL address display area 908, a customization option selectable indicator 910, a title receiving area 912 (having an exemplary page title 922 displayed therein), an author name receiving area 914 (having an exemplary author name 924 displayed therein), an author site receiving area 920, a page description receiving area 916 (having an exemplary page description 940 displayed therein), and a page style option selectable indicator 918.

Upon display of user interface 900, the user is prompted to elect whether to customize the URL-addressable Web page that is to be generated by the Web page generating module 212 of FIG. 2 and associated with one or more user-defined search parameters. The user may elect to customize the page by selecting the customization option selectable indicator 910. Subsequently, the user may input, in association with the appropriate display area(s), a page title 922 (within the title-receiving area 912), an author name 924 (within the author name receiving area 914), information relating to additional Web sites associated with the page author (within the author site receiving area 920), and a page description 940 (within the page description receiving area 916). Additionally, the user is permitted to select a page style by selecting one of the selectable indicators 918 associated with the desired page style.

As indicated by an asterisk next to each display area indicator, in the illustrated embodiment, the page title 922, the author name 924, and the page style 918 are mandatory selections a user must specify if s/he desires to customize the associated Web page. This is due to the fact that the page title 922 and author name 924 are utilized to form the macro name 906, which is displayed in the macro name display area. As can be seen in FIG. 9, the macro name 906 is comprised of the author name 924 followed by the page title 922 and separated by a period; however, a variety of naming conventions that utilize user data are contemplated. Additionally, it will be appreciated and understood by those skilled in the art that there exists alternate methods for configuring the user interface of a URL-addressable Web page and that all such variations are contemplated to be within the scope of embodiments hereof.

Further, the customization options described above are not limiting and alternate configurations have been contemplated by the inventors hereof. One alternate embodiment includes a search browser utility that can search for pictures, files, etc. to upload onto the user interface. Another alternate embodiment provides a feedback utility whereby a user of the URL-addressable Web page may, among other things, rate or provide feedback to the author by selecting a feedback selectable indicator displayed on the user interface. Still another alternate embodiment provides a communication utility whereby a user may share the URL address of a Web page to another user by selecting a share selectable indicator displayed on the user interface.

Turning now to FIGS. 10 and 11, illustrative screen displays of exemplary user interfaces for accepting a search query and displaying search results are shown in accordance with embodiments of the present invention. In FIG. 10 a URL-addressable Web page is shown that has been created with a user-defined page title, author name, and page description, and in FIG. 11, a search query has been executed and the determined results are displayed. Each of these screen displays is described more fully below.

With reference to FIG. 10, a user interface 930 is shown having a query-receiving area 936, a page description display area 940, a page title display area 922, an author name display area 924, an assigned URL address display area 960, and a plurality of links (e.g., links 932 and 934). The page description display area 940, the page title display area 922, and the author name display area 924 are derived from the corresponding user entries in the user interface 900 of FIG. 9. As can be seen, the URL address display area 960 displays the URL associated with the Web page, wherein the URL address includes the page title and the author name within the text thereof. The URL address assists in communicating the associated user-defined search parameters as the URL address may be shared via various methods.

The plurality of links include a selectable email link 932 and a selectable share link 934. The selectable email link 932 may be actuated by the user if s/he desires to send the URL address to another user. That is, selecting the selectable email link 932 will generate an electronic mail message that includes—in the body, title, or attached thereto—the URL address of the Web page. In an exemplary embodiment, the attached URL address is a link that automatically directs an electronic mail recipient to the referenced URL-addressable Web page. The selectable share link 934 provides a share utility whereby the user may publicly share the search macro associated with the URL-addressable Web page in a macro gallery, e.g., stored in association with database 208 of FIG. 2, as discussed above.

Turning now to FIG. 11, a user interface 950 is shown having a query-receiving area 936 (having an exemplary search query 952 displayed therein), and a search result list display area 954 (having a plurality of Web page references 956 displayed therein). The query-receiving area 936 directly corresponds in utility to the query-receiving area 936 of FIG. 10. A search query 952 may be input into the query-receiving area 936 by a user. Upon entry and execution of a search, the determining module 222 (FIG. 2) appends the search query 952 to the user-defined search parameter(s) associated with the URL-addressable Web page. As discussed above, the determining module 222 creates an expanded search query that, when upon search execution, is utilized to determine the search results.

In an exemplary configuration, the search results are comprised of the one or more Web page references 956 that are assigned a level of relevance corresponding to the expanded search query. That is, the determining module 222, when determining the search results, assigns each resultant Web page reference 956 a level of relevance and sorts them accordingly. Subsequently, the display module 224 (FIG. 2) displays the Web page references 956 according to the determined level of relevance. As depicted in FIG. 11, the most relevant Web page references 956 are displayed at an upper portion of the search result list 954 and those search results having a lower level of relevance assigned thereto are displayed further down the list.

As can be understood, and as discussed above, the Web page references 956 can include, amount other things, a Web page title, description of the Web page, text from the Web page, and URL assigned to Web page. In one embodiment, and as depicted in FIG. 11, the Web page references 956 depict the Web page title first and set it off to assist as user in scanning the search result list 954 at the user interface 950. In another embodiment, the URL assigned to the Web page can be displayed as a link, whereby user actuation of the link directs the user's Web browser to the associated Web page. However, it should be understood and appreciated by those skilled in the art that the configuration of the Web page references 956 are not limited to the embodiments described above, and that alternate embodiments of the order, style, and structure of the Web page references 956 are considered by the inventor.

As can be understood, embodiments of the present invention provide computerized methods and systems for generating a URL-addressable Web page utilizing user-defined search parameters. User-defined search parameters are packaged together as a search macro and assigned a URL. When a user accesses the Web page associated with the assigned URL, s/he is permitted to specify a search query and any search results returned in response thereto will be tailored in accordance with the user-defined search parameters, even though such search parameters are not input as part of the search query. Further embodiments of the present invention provide users with the opportunity to readily share packaged search parameters with other users by simply communicating the URL assigned to a particular search macro.

The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and sub-combinations are of utility and may be employed without reference to other features and sub-combinations. This is contemplated by and is within the scope of the claims.

What is claimed is:

1. One or more computer-readable media having computer-executable instructions embodied thereon for performing a method for generating a uniform resource locator (URL)-addressable Web page utilizing at least one user-defined search parameter, the method comprising:
receiving the at least one user-defined search parameter; and
automatically generating the URL-addressable Web page, the URL-addressable Web page being associated with the at least one user-defined search parameter.

2. The one or more computer-readable media of claim 1, further comprising assigning a URL to the URL-addressable Web page.

3. The one or more computer-readable media of claim 2, further comprising:
receiving a request to communicate the at least one user-defined search parameter; and
in response to the received request, communicating the assigned URL.

4. The one or more computer-readable media of claim 1, further comprising displaying the URL-addressable Web page, the URL-addressable Web page having a query-receiving area associated therewith configured to receive at least one search query.

5. The one or more computer-readable media of claim 4, further comprising:
receiving, in association with the query-receiving area, a search query; and
determining one or more search results utilizing the search query and the at least one user-defined search parameter.

6. The one or more computer-readable media of claim 5, wherein determining one or more search results utilizing the search query and the at least one user-defined search parameter comprises:
appending the at least one user-defined search parameter to the search query to generate an expanded search query; and
determining the one or more search results utilizing the expanded search query.

7. The one or more computer-readable media of claim 5, further comprising displaying the one or more determined search results.

8. The one or more computer-readable media of claim 1, wherein the method further comprises receiving at least one user-defined customization value associated with the URL-addressable Web page.

9. The one or more computer-readable media of claim 8, wherein the at least one user-defined customization value comprises one or more of a Web page title, a Web page author identification, a Web page description, a Web page graphical appearance indicator, and a security level.

10. A computer system for generating a uniform resource locator (URL)-addressable Web page utilizing at least one user-defined search parameter, the system comprising:
a search parameter receiving module configured to receive the at least one user-defined search parameter;
a Web page generating module configured to generate the URL-addressable Web page upon receipt of the at least one user-defined search parameter; and
a URL assigning module configured to assign a URL to the generated URL-addressable Web page.

11. The computer system of claim 10, further comprising a customization value receiving module configured to receive at least one user-defined customization value associated with the URL-addressable Web page.

12. The computer system of claim 11, wherein the at least one user-defined customization value comprises one or more of a Web page title, a Web page author identification, a Web page description, a Web page graphical appearance indicator, and a security level.

13. The computer system of claim 10, further comprising a communication module configured to receive a request to communicate the at least one user-defined search parameter and, in response to the received request, communicate the assigned URL.

14. The computer system of claim 10, further comprising:
a search query receiving module configured to receive a search query; and
a determining module configured to determine one or more search results utilizing the search query and the at least one user-defined search parameter.

15. The computer system of claim 14, further comprising a display module configured to display one or more of the URL addressable Web page and the one or more determined search results.

16. A computerized method for determining at least one search result associated with a search query, the method comprising:
receiving a request to display a uniform resource locator (URL) addressable Web page associated with at least one user-defined search parameter;
receiving a search query; and
determining the at least one search result associated with the search query utilizing the received search query and the at least one user-defined search parameter.

17. The computerized method of claim 16, wherein determining the at least one search result associated with the search query utilizing the received search query and the at least one user-defined search parameter comprises:
appending the at least one user-defined search parameter to the search query to generate an expanded search query; and
determining the at least one search result utilizing the expanded search query.

18. The computerized method of claim 16, further comprising, in response to the received request, displaying the URL-addressable Web page associated with the at least one user-defined search parameter, the URL-addressable Web page having a query-receiving area associated therewith.

19. The computerized method of claim 18, wherein receiving a search query comprises receiving the search query in association with the query-receiving area.

20. The computerized method of claim 16, further comprising displaying the at least one determined search result.
